(19) United States
(12) Patent Application Publication
(10) Pub. No.: US 2012/0133603 A1
(43) Pub. Date: May 31, 2012

(54) FINGER RECOGNITION METHODS AND SYSTEMS

(75) Inventor: Kim Yeung Sip, Taipei Hsien (TW)

(73) Assignee: ACER INCORPORATED, Taipei Hsien (TW)

(21) Appl. No.: 13/303,834

(22) Filed: Nov. 23, 2011

(30) Foreign Application Priority Data
Nov. 26, 2010 (TW) 99140938

(51) Int. Cl. G06F 3/041

(52) U.S. Cl. 345/173

(57) ABSTRACT

Finger recognition methods and systems for use in an electronic device are provided. First, a contact corresponding to an input tool is detected via a touch-sensitive device, and a shape corresponding to the input tool is obtained according to the contact. It is determined whether the shape corresponding to the input tool conforms to a shape corresponding to the at least one finger recorded in a database. If so, the input tool is determined to be a finger.

### CROSS REFERENCE TO RELATED APPLICATIONS

This Application claims priority of Taiwan Patent Application No. 099140938, filed on Nov. 26, 2010, the entirety of which is incorporated by reference herein.

### BACKGROUND OF THE INVENTION

1. Field of the Invention

The disclosure relates generally to finger recognition methods and systems, and, more particularly to methods and systems that determine whether an input tool is a finger based on a contact detected on a touch-sensitive device.

2. Description of the Related Art

Recently, portable devices, such as mobile computers, mobile phones, smart phones, PDAs (Personal Digital Assistants), and e-book devices, have become more and more technically advanced and multifunctional. Due to increased convenience and functions of the devices, these devices have become basic life necessities.

Currently, a handheld device may be equipped with a touch-sensitive screen to display data and receive related input via the touch-sensitive screen. For example, when an application is executed in the device, a user can use a finger to perform contact and movements on the touch-sensitive screen, thereby inputting related data and commands to control the operations of the application. Due to the operational convenience of the touch-sensitive screens, the touch-sensitive screens have become one of the popular input interfaces for the devices of the current generation.

Generally, the most popular type of touch technology is the projected capacitance touch screen technology since the projected capacitance touch screen technology is very sensitive and easy to operate. However, a problem may occur for users, such as users of a smart phone, wherein unintentional phone calls are made after the smart phone is placed inside a pocket after an intentional call is made. This occurs, because the projected capacitance touch technology is so sensitive, that it will mistakenly detect the skin of users, through the thin cloth of their pockets, as an intentional touch input. Accordingly, software applications will mistakenly make phone calls from a list, due to the unintentional input detection.

Conventionally, some devices can provide a screen lock function to prevent unintended touch detection. When users want to use the touch-sensitive screen, users can unlock the touch-sensitive screen by a specific button or a specific contact gesture. However, the method of the conventional art is inconvenient for users, and the required settings and operations of related hardware will also consume system resources, such as power and processing efficiency of processing units.

Generally, most users use their fingers to contact the touch-sensitive screen for related inputs and applications. Therefore, an efficient mechanism to determine whether an input tool is a finger may become one of the solutions to mitigate the above issue.

### BRIEF SUMMARY OF THE INVENTION

Finger recognition methods and systems are provided.

In an embodiment of a finger recognition method for use in an electronic device, a contact corresponding to an input tool is detected via a touch-sensitive device, and a shape corresponding to the input tool is obtained according to the contact. It is determined whether the shape corresponding to the input tool conforms to a shape corresponding to the at least one finger recorded in a database. When the shape corresponding to the input tool conforms to the shape corresponding to the at least one finger recorded in the database, the input tool is determined to be a finger.

An embodiment of a finger recognition system for use in an electronic device includes a storage unit, a touch sensitive device, and a processing unit. The storage unit includes a database for recording a shape corresponding to the at least one finger. The touch sensitive device detects a contact corresponding to an input tool. The processing unit obtains a shape corresponding to the input tool according to the contact, and determines whether the shape corresponding to the input tool conforms to the shape corresponding to the at least one finger recorded in the database. When the shape corresponding to the input tool conforms to the shape corresponding to the at least one finger recorded in the database, the input tool is determined to be a finger.

In some embodiments, the shape corresponding to the input tool can be performed with at least one predefined transformation, and it is determined whether the transformed shape corresponding to the input tool conforms to the shape corresponding to the at least one finger recorded in the database. In some embodiments, the predefined transformation is used to rotate the shape corresponding to the input tool in various angles, or to simulate the shapes corresponding to the input tool while contacting the touch-sensitive device in various angles.

In some embodiments, the database can further record at least one predefined transformation of the shape corresponding to the at least one finger. In some embodiments, the predefined transformation is used to rotate the shape corresponding to the at least one finger in various angles, or to simulate the shapes corresponding to the at least one finger while contacting the touch-sensitive device in various angles. In some embodiments, it is determined whether the shape corresponding to the input tool conforms to the predefined transformation of the shape corresponding to the at least one finger recorded in the database. When the shape corresponding to the input tool conforms to the predefined transformation of the shape corresponding to the at least one finger recorded in the database, the input tool is determined to be a finger.

In some embodiments, when the input tool is determined to be a finger, a function is performed or an application, such as a dial application is activated.

In some embodiments, the sensor resolution of the touch-sensitive device equals to or is less than 4 mm, and the sample rate of the touch-sensitive device is not less than 60 Hz.

Finger recognition methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a finger recognition system of the invention;

FIG. 2 is a schematic diagram illustrating an embodiment of an example of a shape corresponding to a finger of the invention;

FIGS. 3A, 3B and 3C are schematic diagrams illustrating examples of predefined transformations of the shape corresponding to the finger in FIG. 2;

FIG. 4 is a flowchart of an embodiment of a finger recognition method of the invention; and

FIG. 5 is a flowchart of another embodiment of a finger recognition method of the invention.

### DETAILED DESCRIPTION OF THE INVENTION

Finger recognition methods and systems are provided.

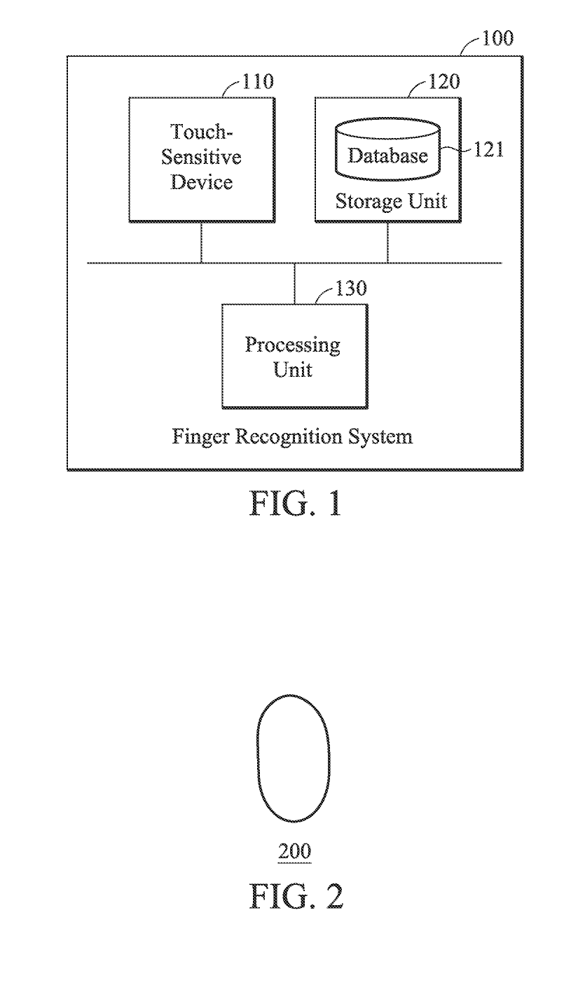

FIG. 1 is a schematic diagram illustrating an embodiment of a finger recognition system of the invention. The finger recognition system 100 can be used in an electronic device, such as a mobile computer, a mobile phones, a smart phone, a PDA (Personal Digital Assistants), or an e-book device.

The finger recognition system 100 comprises a touch-sensitive device 110, a storage unit 120, and a processing unit 130. The touch-sensitive device 110 has a touch-sensitive surface comprising sensors in at least one dimension to detect contact and movement of an input tool, such as a stylus or finger on the touch-sensitive surface. It is understood that, in some embodiments, the touch-sensitive device 110 may be a capacitive-type touch-sensitive device 110. In some embodiments, for best results, the sensor resolution of the touch-sensitive device 110 equals to or is less than 4 mm, and the sample rate of the touch-sensitive device 110 is not less than 60 Hz. Additionally, in some embodiments, the sample rate of the touch-sensitive device 110 can be adjusted according to the number of contacts. For example, when the number of contacts is large, the sample rate of the touch-sensitive device 110 can be raised. It is noted that, the sensor resolution and the sample rate of the touch-sensitive device 110 are only examples of the present application, and the present invention is not limited thereto.

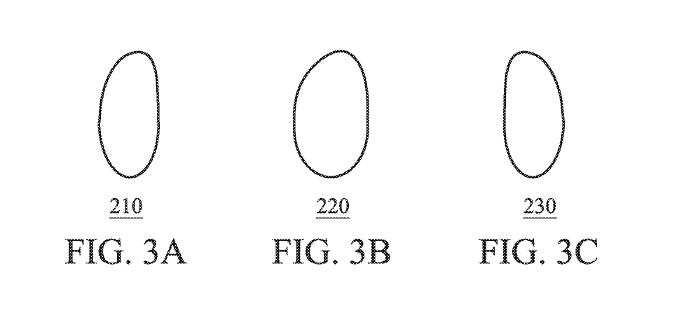

The storage unit 120 comprises a database 121. The database 121 can at least record a shape 200 corresponding to the at least one finger, as shown in FIG. 2. It is noted that, since uses may use different fingers for input and operation, the database 121 can record shapes corresponding to various fingers, such as a thumb, a forefinger, a middle finger, a ring finger, and a little finger of a right hand or a left hand. Further, since different aged, sex and/or race users may have different finger shapes, the database 121 may also respectively record the shapes corresponding to the different finger characteristics of users. Additionally, in some embodiments, the database 121 can also record at least one predefined transformation of a shape corresponding to a finger. The predefined transformation is used to rotate the shape corresponding to the finger in various angles, and/or to simulate the shapes corresponding to the finger while contacting the touch-sensitive device 110 in various angles. For example, FIGS. 3A, 3B and 3C are schematic diagrams illustrating examples of predefined transformations (210, 220, and 230) of the shape 200 corresponding to the finger in FIG. 2. It is understood that, in some embodiments, the predefined transformation of the shape corresponding to the finger is not needed to be recorded in the database 121. When the shape corresponding to the input tool is obtained, the shape corresponding to the input tool can be performed with the predefined transformation, thus to obtain the shape corresponding to the input tool rotated in various angles, and/or the shapes corresponding to the input tool while simulating contact with the touch-sensitive device in various angles. The processing unit 130 performs the finger recognition methods of the invention, which will be discussed further in the following paragraphs.

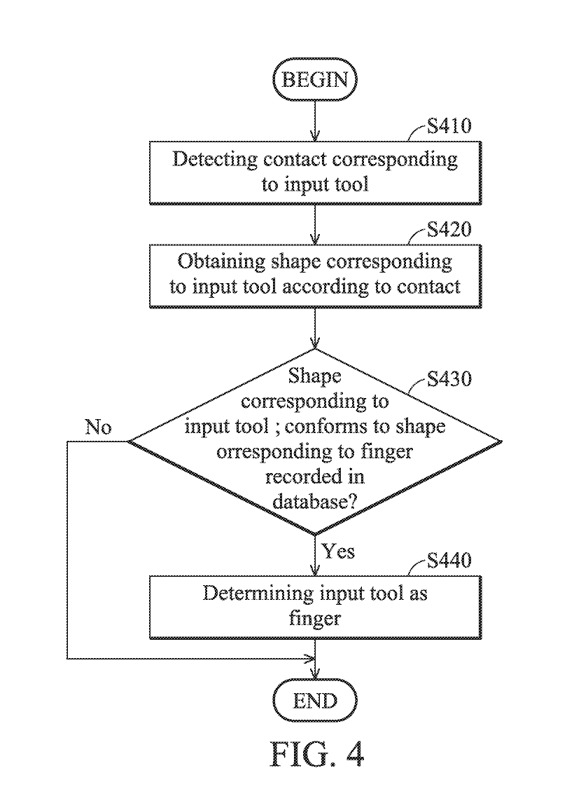

FIG. 4 is a flowchart of an embodiment of a finger recognition method of the invention. The finger recognition method can be used in an electronic device, such as a mobile computer, a mobile phones, a smart phone, a PDA (Personal Digital Assistants), or an e-book device.

In step S410, a contact corresponding to an input tool is detected via a touch-sensitive device, and in step S420, a shape corresponding to the input tool is obtained according to the contact. It is understood that, in some embodiments, the touch-sensitive device may be a capacitive-type touch-sensitive device. The shape corresponding to the input tool can be obtained based on the contact corresponding to the input tool on the capacitive-type touch-sensitive device. In step S430, it is determined whether the shape corresponding to the input tool conforms to a shape corresponding to the at least one finger recorded in the database. When the shape corresponding to the input tool does not conform to the shape corresponding to the at least one finger recorded in the database (No in step S430), the input tool is determined to not be a finger, and the procedure is terminated. When the shape corresponding to the input tool conforms to the shape corresponding to the at least one finger recorded in the database (Yes in step S430), in step S440, the input tool is determined to be a finger. It is understood that, in some embodiments, the database can also record at least one predefined transformation of the shape corresponding to the at least one finger. As described, the predefined transformation is used to rotate the shape corresponding to the at least one finger in various angles, and/or to simulate the shapes corresponding to the at least one finger while contacting the touch-sensitive device in various angles. When the at least one predefined transformation of the shape corresponding to the at least one finger is recorded in the database, in step S430, it is also determined whether the shape corresponding to the input tool conforms to the predefined transformation of the shape corresponding to the at least one finger recorded in the database. When the shape corresponding to the input tool conforms to the predefined transformation of the shape corresponding to the at least one finger recorded in the database, the input tool is determined to be a finger.

It is noted that, in some embodiments, when the input tool is determined to be a finger, a function can be performed or an application can be activated. For example, the electronic device can activate a dial application, and a user can perform a dial operation using the dial application.

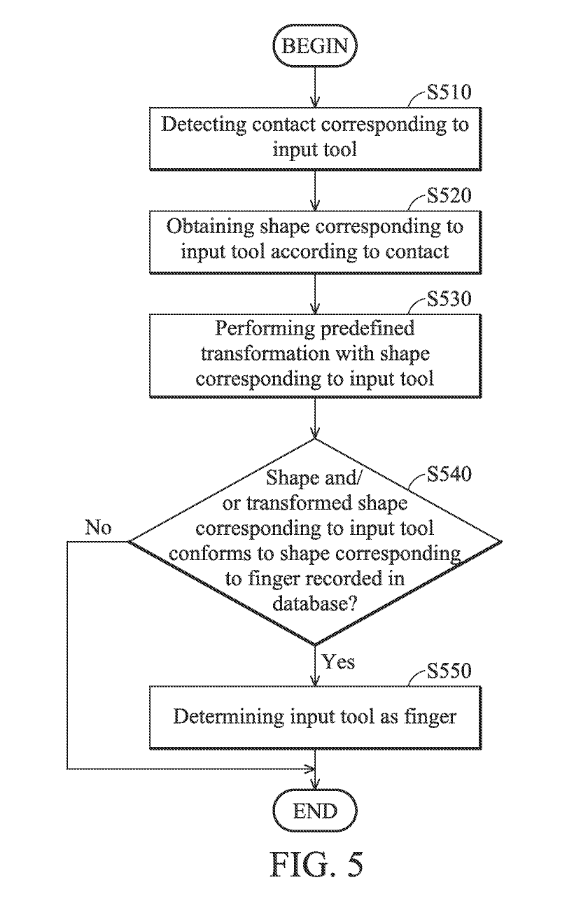

FIG. 5 is a flowchart of another embodiment of a finger recognition method of the invention. The finger recognition method can be used in an electronic device, such as a mobile computer, a mobile phones, a smart phone, a PDA (Personal Digital Assistants), or an e-book device.

In step S510, a contact corresponding to an input tool is detected via a touch-sensitive device, and in step S520, a shape corresponding to the input tool is obtained according to the contact. Similarly, in some embodiments, the touch-sensitive device may be a capacitive-type touch-sensitive device. The shape corresponding to the input tool can be obtained based on the contact corresponding to the input tool on the capacitive-type touch-sensitive device. In step S530, the shape corresponding to the input tool is performed with at least one predefined transformation. Similarly, the predefined transformation is used to rotate the shape corresponding to the input tool in various angles, and/or to simulate the shapes corresponding to the input tool while contacting the touch-sensitive device in various angles. In step S540, it is determined whether the shape and/or the transformed shape corresponding to the input tool conforms to the shape corresponding to the at least one finger recorded in the database. When the shape and the transformed shape corresponding to the input tool do not conform to the shape corresponding to the at least one finger recorded in the database (No in step S540), the input tool is determined to not be a finger, and the procedure is terminated. When the shape or the transformed shape corresponding to the input tool conforms to the shape corresponding to the at least one finger recorded in the database (Yes in step S540), in step S550, the input tool is determined to be a finger. Similarly, in some embodiments, when the input tool is determined to be a finger, a function can be performed or an application can be activated. For example, the electronic device can activate a dial application, and a user can perform a dial operation using the dial application.

Therefore, the finger recognition methods and systems can determine whether an input tool is a finger based on the contact corresponding to the input tool detected on a touch-sensitive device, thus to determine whether to provide subsequent functions or applications. In the present application, an effective touch-sensitive recognition mechanism can be provided, thus to reduce resource consumption, such as power and processing efficiency of a processing unit required for settings and operations of related hardware.

Finger recognition methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed:

1. A finger recognition method for use in an electronic device, comprising:
providing a database, wherein the database records a shape corresponding to at least one finger;
detecting a contact corresponding to an input tool via a touch-sensitive device;
obtaining a shape corresponding to the input tool according to the contact;
determining whether the shape corresponding to the input tool conforms to the shape corresponding to the at least one finger recorded in the database; and
when the shape corresponding to the input tool conforms to the shape corresponding to the at least one finger recorded in the database, determining the input tool to be a finger.

2. The method of claim 1, further comprising:
performing at least one predefined transformation with the shape corresponding to the input tool; and
determining whether the transformed shape corresponding to the input tool conforms to the shape corresponding to the at least one finger recorded in the database.

3. The method of claim 2, wherein the predefined transformation is used to rotate the shape corresponding to the input tool in various angles, or to simulate the shapes corresponding to the input tool while contacting the touch-sensitive device in various angles.

4. The method of claim 1, wherein the database further records at least one predefined transformation of the shape corresponding to the at least one finger, wherein the predefined transformation is used to rotate the shape corresponding to the at least one finger in various angles, or to simulate the shapes corresponding to the at least one finger while contacting the touch-sensitive device in various angles, and the method further comprises:
determining whether the shape corresponding to the input tool conforms to the predefined transformation of the shape corresponding to the at least one finger recorded in the database; and
when the shape corresponding to the input tool conforms to the predefined transformation of the shape corresponding to the at least one finger recorded in the database, determining the input tool to be a finger.

5. The method of claim 1, wherein the sensor resolution of the touch-sensitive device equals to or is less than 4 mm, and the sample rate of the touch-sensitive device is not less than 60 Hz.

6. The method of claim 1, further comprising performing a function or activating an application when the input tool is determined to be a finger.

7. The method of claim 6, wherein the application comprises a dial application.

8. A finger recognition system for use in an electronic device, comprising:
a storage unit comprising a database, wherein the database records a shape corresponding to at least one finger;
a touch-sensitive device detecting a contact corresponding to an input tool via a touch-sensitive device; and
a processing unit obtaining a shape corresponding to the input tool according to the contact, determining whether the shape corresponding to the input tool conforms to the shape corresponding to the at least one finger recorded in the database, and when the shape corresponding to the input tool conforms to the shape corresponding to the at least one finger recorded in the database, determining the input tool to be a finger.

9. The system of claim 8, wherein the processing unit further performs at least one predefined transformation with the shape corresponding to the input tool, and determines whether the transformed shape corresponding to the input tool conforms to the shape corresponding to the at least one finger recorded in the database.

10. The system of claim 9, wherein the predefined transformation is used to rotate the shape corresponding to the input tool in various angles, or to simulate the shapes corresponding to the input tool while contacting the touch-sensitive device in various angles.

11. The system of claim 8, wherein the database further records at least one predefined transformation of the shape corresponding to the at least one finger, wherein the predefined transformation is used to rotate the shape corresponding to the at least one finger in various angles, or to simulate the shapes corresponding to the at least one finger while contacting the touch-sensitive device in various angles, and the processing unit further determines whether the shape corresponding to the input tool conforms to the predefined transformation of the shape corresponding to the at least one finger recorded in the database, and when the shape corresponding to the input tool conforms to the predefined transformation of the shape corresponding to the at least one finger recorded in the database, the processing unit determines the input tool to be a finger.

12. The system of claim 8, wherein the sensor resolution of the touch-sensitive device equals to or is less than 4 mm, and the sample rate of the touch-sensitive device is not less than 60 Hz.

13. The system of claim 8, wherein the processing unit further performs a function or activates an application when the input tool is determined to be a finger.

14. The system of claim 13, wherein the application comprises a dial application.

15. A machine-readable storage medium comprising a computer program, which, when executed, causes a device to perform a finger recognition method, wherein the method comprises:
detecting a contact corresponding to an input tool via a touch-sensitive device;
obtaining a shape corresponding to the input tool according to the contact;
determining whether the shape corresponding to the input tool conforms to a shape corresponding to at least one finger recorded in a database; and
when the shape corresponding to the input tool conforms to the shape corresponding to the at least one finger recorded in the database, determining the input tool to be a finger.
